(19) United States
(12) Patent Application Publication
(10) Pub. No.: US 2005/0237555 A1
(43) Pub. Date: Oct. 27, 2005

(54) Method for counting POS printing of graphic objects

(76) Inventors: Theron A. Wildey, Ithaca, NY (US); Andrew Kobziar, Ithaca, NY (US); Andrew B. Nye III, Skaneateles, NY (US)

Correspondence Address: BOND, SCHOENECK & KING, PLLC, ONE LINCOLN CENTER, SYRACUSE, NY, 13202-1355, US

(21) Appl. No.: 10/778,481

(22) Filed: Feb. 13, 2004

Related U.S. Application Data
(60) Provisional application No. 60/448,183, filed on Feb. 14, 2003.

(51) Int. Cl. G06F 15/00

(52) U.S. Cl. 358/1.13; 358/1.15

(57) ABSTRACT

A method for counting the number of times a graphic object is printed by a POS system. If a graphic object is to be printed, its predetermined ID (or type ID in the case of a surround graphic) is looked up in the counting table and, if present, the count is incremented. If the incrementing of the count results in a counter rollover, the event is recorded in the Flash memory and the RAM table for later status reporting. Finally, a check is made to see if the update interval has been reached and, if so, the value is written to the Flash memory and incremental counting is restarted.

### CROSS-REFERENCE TO RELATED APPLICATIONS

The present application claims priority to U.S. Provisional Application Ser. No. 60/448,183 of the same title, filed on Feb. 14, 2003, and hereby incorporated by reference.

### BACKGROUND OF THE INVENTION

1. Field of Invention

The present invention relates to in point-of-sale (POS) systems and, more specifically, to a method for counting the number of times graphic objects are printed.

2. Description of Prior Art

POS printers play a supportive role in retail and financial business systems that is shaped by both business needs and the technical capabilities of the printer. As POS printers now have the ability to print color graphics, the standard role of the POS printer is being reexamined to fulfill more business needs. For example, POS systems can lower the costs of product promotion by more effectively utilizing the technical capabilities of the POS printers while fulfilling marketing needs.

A POS receipt contains different types of data or, more technically, a POS receipt is composed of printed objects that belong to different classes of object types. Certain printed objects are not just transactional textual information. Instead, these objects carry other information of potential financial value. For example, the object may present a product or store promotion, or even a simple message like “County Fair Tonight.” While humans can readily distinguish between graphical promotions, it is difficult for the POS system to do so from a bit and byte point-of-view.

When a particular promotion uses printed graphic objects, there may be a need to account for printing of these objects in order to realize the financial benefits of agreements covering such printing. As conventional POS systems are unable to distinguish between graphic promotions and cannot track the printing of certain graphic objects, the full capabilities of modem POS printers are unrealized.

A high-level division of print data that can be recognized by a POS printer is the distinction between text and graphics. The conventional distinction between graphics is limited to a small set of commands that deal with graphic objects. Pre-defined graphics that are repeatedly printed are referred to as “logos” and typically are stored in static (Flash) memory. Logo graphics are now a standard feature in several conventional POS printers.

More technically, there are two major classes of graphics relevant to POS graphical applications—bit mapped graphics and surround graphics. The bit map class of graphics has two further subclasses; stored bit maps, called logos, and dynamically supplied bit rasters. Regarding the logo class of graphics (i.e., stored bit maps), some conventional POS printers provide a single datum in addition to the bit map itself to reflect the index value at the time the logo was downloaded. Other POS printers may provide an additional datum that indicates whether or not the logo can be used in merged printing as a watermark. Neither method is sufficient, however, to allow a POS system to track the print count of various graphics.

### 3. OBJECTS AND ADVANTAGES

It is a principal object and advantage of the present invention to lower the costs of product promotion.

It is an additional object and advantage of the present invention to provide a method for counting the number of times a graphic object is printed.

It is a further object and advantage of the present invention to enhance the functionality of POS printers used in business applications.

Other objects and advantages of the present invention will in part be obvious, and in part appear hereinafter.

### SUMMARY OF THE INVENTION

In accordance with the foregoing objects and advantages, the present invention provides a method for counting the number of times a graphic object is printed by a POS printer. Individual counts are kept for each logo and surround type graphic and then periodically updated into the non-volatile storage of the printer to retain the count in the event of an intentional or unintentional power loss. The counts may be read, cleared, or set to a predetermined value through commands. The cyclic redundancy check (CRC) of a logo enables positive identification for reporting of counts and assignment to index values that the application can use to have different sets of logos play the same roles on a receipt.

### BRIEF DESCRIPTION OF THE DRAWINGS

FIG. 1 is a high-level flow chart of a method of counting printed graphic according to the present invention.

FIG. 2 is a high-level flow chart of the initialization process of a POC system programmed according to the present invention.

### DETAILED DESCRIPTION

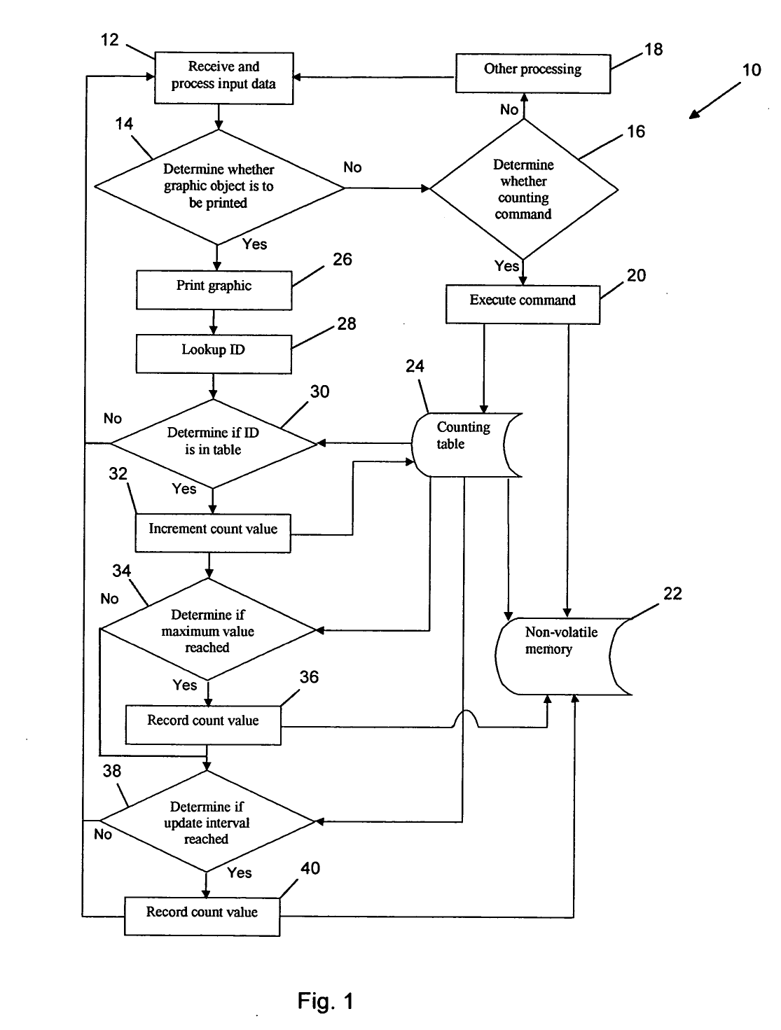

Referring now to the drawings, wherein like numerals refer to like parts throughout, there is seen in FIG. 1 a process 10 for counting the number of times a particular graphic object is printed by a POS system by adding a meta datum—the print count—to graphic objects.

The first step in the method of the present invention is to receive and process input data 12 according to conventional POS printing processes. Once received, the data is examined to determine whether a graphic object is to be printed 14. If a graphic object is not to be printed, the data is checked to determine whether a counting command 16 is present, as will be described in detail below. If the data does not include a counting command, other processing 18, e.g., printing 18, may occur and control passes back to step 12. If the data does include a counting command, the command is executed 20 and the appropriate action is taken in the non-volatile memory 20 and/or counting table 22. For example, if the command is to turn counting on, an entry is added to the Flash memory stack, and the next-free space pointer is increased.

If it is determined that a graphic object is to be printed 14, the graphic is printed 26 and its predetermined graphic identifying code (ID), such as a CRC or type ID (in the case of a surround graphic) is looked up 28 in counting table 24. If graphic ID is determined to be present in table 24, the count value for the appropriate graphic ID in table 24 is incremented 32. If the graphic ID is not found in counting table 24, control return to step 12.

If, after incrementing 32, the count value in table 24 is determined to reach a maximum value 34, i.e., a counter “rollover,” the count value is recorded 34 in non-volatile memory 22, such as Flash, for future status reporting.

Finally, a check is made to determine if the update interval (either count or time) has been reached 36 and, if so, the value of the count in table 24 is written 38 to the Flash 22 and incremental counting is restarted or reset. Processing then returns to receive and process input data 12.

In order to minimize the overhead that the present invention presents, the print counts are stored using the fastest memory in the printer. This is normally dynamic random access memory (RAM), which has the undesirable attribute of losing its content when printer power is removed. Accordingly, the present invention covers the most difficult case of having to periodically back-up the print counts to non-volatile storage in the event of a power loss. The process of the present invention would work equally well, however, if the counts were directly updated to some rewriteable form of non-volatile storage.

The counting of printer-distinguishable graphic objects requires the definition of new printer commands that can implement the desired functions. These commands are necessary to control the type of count storage, provide start and stop management, and allow the POS application to read or reset the stored counts.

With regard to logo-type graphics, the commands are designed to turn counting on or off on a per printed logo basis, read current count values of specified logos and set the count to a specified value. The commands must also determine if a logo counter has “rolled over,” periodically store a count in non-volatile memory based on a predetermined increment value or time interval, return the CRCs for a logo, and verify that the graphic is stored at a designated index.

With regard to surround type graphics, the commands are designed to selectively turn the counting on or off based on the surround choice, read the current count values of specified surround graphic type and reset the count to a specified value, and determine if a surround graphic counter has “rolled over.”

Following is a list of example commands for implementing the present invention, the parameters for the commands, the returns, if any, and the function the commands provide.
Command: Set logo count storage mode
Parameters: Count increment or time interval for non-volatile storage.
Function: Designates if the non-volatile storage will be periodically updated every time the count increment is reached for all logos that are counted. A 0 increment indicates RAM only, other values indicate periodic non-volatile storage.
Command: Set logo counting
Parameters: Logo IDnumber, counting on-off switch
Function: Turns counting on or off for a logo and sets the count start value. Counting is automatically suspended if the logo is replaced with a new downloaded logo at the same ID.
Command: Return logo count.
Parameters: Logo ID number, reset count switch, 2 byte reset value
Returns: Logo ID number, logo 2-byte CRC, 2 byte count, status flag (which can say counting is off, or count value overflowed). Overflow state is reset by this command.
Function: Returns the count and CRC of the designated logo and the status of counting. This command also optionally resets the current value.
Command: Set surround graphics count storage mode
Parameters: Off, or RAM only or non-volatile storage also switch, count increment or time interval for NV storage, surround line types (0-5 or FFh=all)
Function: Designates if non-volatile storage will be periodically updated every time the count increment is reached for any surround line that is counted. A 0 increment indicates RAM only, other values indicate periodic NV storage.
Command: Return surround type count
Parameters: Surround type, reset count switch, 2 byte reset value
Returns: Surround type, 2 byte count, status flag (counting is off, or count value overflowed)
Function: Returns the count of the designated surround type and status of counting. Optionally also resets the current value.

The surround type parameter takes on the same values as the printer has defined for surround graphics. Note that a count value may be returned with status flag indicating counting has not been turned on for implementations that always count.

Counting is implemented by a table structure; implementation choice for the count is either a 2-byte or a 4-byte field. An example of a count table appears below in Table 1. In all tables shown, the order of columns is an implementation choice.

| | | | |
|---|---|---|---|
| | | | repetition rate, |
| logo/surround | off-on-NV | count value and | time |
| ID | switch | rollover flag | parameter |

In addition to the tracking the graphic object print count, the preferred embodiment of the present invention comprises two additional printer capabilities. First, the method of the present invention provides the ability to retain and reestablish the counting behavior around printer power cycles. This ability can be an always-on feature of the printer that is a configuration option selected by command or a switch set through the printer configuration interface. Second, the method of the present invention provides the ability to use logo CRC values as the stored object identifiers, so that different subsets of logos can be used by an application in the same manner. For example, the logos that are associated with a knife cut (these have fixed logo IDs) can be switched to another set without the need to dynamically download and override the set that is presently assigned.

While CRCs of typical quantities of graphical printer objects are practically unique, there is a small possibility of different logos having equal CRCs. The printer handles this just as it now handles reused logo indexes—only the last one will be “remembered.” It is up to the application to detect any equivalence and adjust the graphic for a different CRC result, or accept the possible loss of reference to the old graphic.
Command: Assign logo
Parameters: LogoCRC, logo index
Function: Assign the given logo index to the logo with the specified CRC

Either the ASCII string or the CRC must be non-null. While CRCs of typical quantities of graphical printer objects are practically unique, there is a small possibility of different logos having equal CRCs. In the same manner, if an ASCII string (up to 24 characters) is used to “name” the logo, the set of such names in the printer should be unique. In cases of equals, the printer handles this just as it now handles reused logo indexes—only the last one will be “remembered.” It is up to the application to detect equivalence and tweak the graphic for a different CRC result, use a different ASCII string, or accept the loss of being able to reference to the old graphic. Logo default priority value of 0 is highest, FF is lowest, is used to order printout when two or more logos having the same (application determined) role. If the priority is the same then the resulting order is undetermined.

This command fills Table 2 as follows:

TABLE 2

| | | | |
|---|---|---|---|
| | logo | | memory storage |
| ASCII string | CRC | logo ID | address |

Command: Configure indexing and counting retention
Parameters: Restoration switch, reestablish flags: logo counting and surround graphic counting
Function: On boot-up, the preserved indexing data and counting is reestablished with values set to those most recently saved.

A time sequence problem arises from the need to re-create the RAM based counting table across (usually inadvertent) power cycles of the printer. Logos and other objects are stored in Flash memory when they are created, but at latter times some of the logos and surround graphic types may be designated to be counted. Additionally, by command definition, some of the counts are periodically updated into non-volatile storage. The present invention provides a method to save this information. Since the information comes into the printer unordered, the method of the present invention creates a stack-like list in Flash memory that is reviewed on boot-up to both restore and continue the counting and indexing functions. At the time a count assignment or indexing command is received by the printer, its information is “stack pushed” into next unused Flash memory words, in a format for power fail recovery repopulation of operation tables into RAM. A similar stacking for count current values is done every time a count exceeds the increment value.

One or more sectors (a sector is the minimal erasable quanta) of flash memory is configured for retention of these count and indexing assignments. At boot-up these sectors are read from newest to oldest to recreate the values and assignments before power loss. Note that for correct operation, a command terminating an assignment is also stacked, since the restore task needs this information to ignore all earlier count updates and the index creating commands that may have preceded the termination. The Flash “count assignments” sector(s) stack is seen below in Table 3.

TABLE 3

| | | |
|---|---|---|
| | | object type/previous item of |
| object ID | value area | same type |

If all objects of the same type fit into the same size, then a previous item pointer can be replaced with a simple size subtraction operation to get to the previous entry in the stack. In this case the object type field would be the last one stored. Object type is a logo assignment, or count increment, or counting command function, etc. and object ID is the value of the application referencing ID. The value area holds the object creation parameter(s) or current count value of the object, or its current role assignment. As an example, type=count entry, object=logo index ID, value=current count, object type=logo.

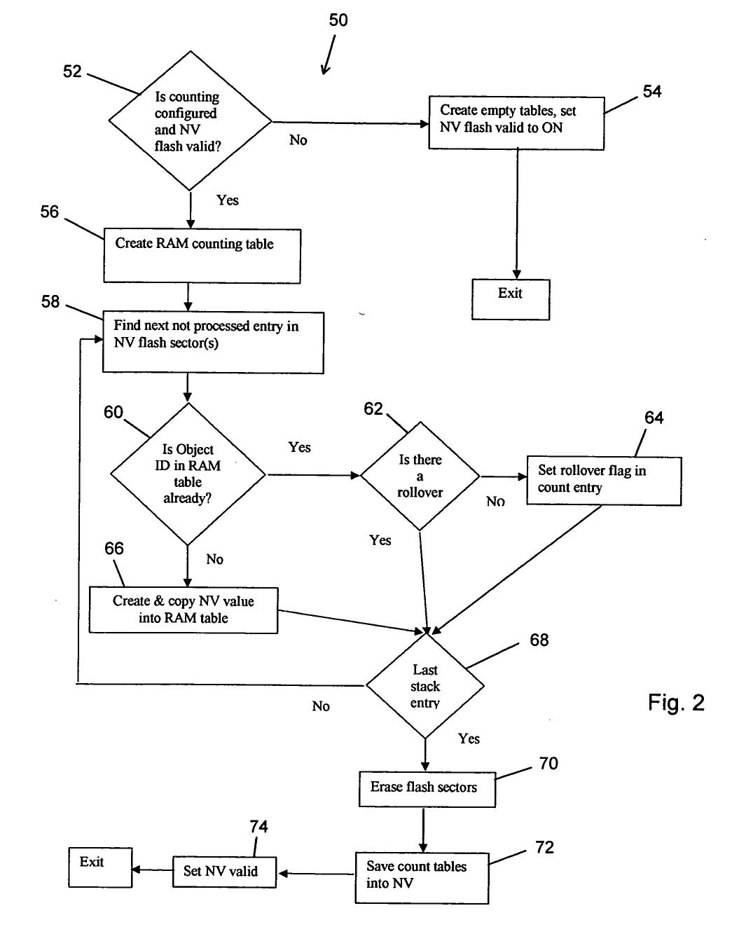

At boot-up a countdown search module 50 is done to find the top of the stack (head of the list), which is then processed to fill the index assignment(s) and counting tables in RAM. The steps for this process are illustrated in FIG. 2.

If restoration has been configured 52, creation and population of the count table 54 is done from the saved values in the NV memory that was used for saving counts and role reassignments. The count table may be created to cover all possible objects or on a needed object by object basis, depending on which method the application chooses to manage the table.

The latest unprocessed NV entry 58 is found by scanning for a value that is not the erasure value of Flash; once found, the list is processed from newest to oldest. If the object ID already has a processed entry in RAM 60, a check 62 is made if the rollover indicator should also be set.

If the object had not been seen before, then this NV entry holds its latest (restorable) value and is copied to RAM 66. Role assignment and turning counting off events are also fed into the RAM counting table 68. Otherwise, the NV entry is older than a previously processed one so it is skipped.

Once all the NV entries have been looked at, the configuration switch indicating good Flash data is unset and the NV flash memory is erased 70, and a full set of starting entries (the ones needed for a subsequent restore) are written from the RAM count table onto the flash stack 72, and the configuration switch showing that flash has saved data is set 74. This restore method has one critical time period, where loss of power during the erasure and starting value setup results in loss of the saved values.

Using the methods of the present invention, the user of a POS system has the ability to assign different logos to act in marketing determined roles, allowing the application to either control logos by index number or role name. A user can also have more than one logo fulfill a role, with the print order established by priority.

With regard to tracking the printing of logos, a user may turn counting on or off on a per logo ID basis and can get current count values of specified logo IDs, and reset the count. On the other hand, the user can tell if a logo counter has “rolled over.” The counts may be periodically, based on an increment value or time, stored in non-volatile (NV) RAM. The present invention also allows for the return of CRCs for a logo, allowing the application to verify the graphic that is stored at a designated index ID.

Counting of surround graphics may be selectively turned on or off based on the surround choice and the current count values of specified surround graphic type may be retrieved or reset. As with logos, the present invention allows a user to tell if a surround graphic type counter has “rolled over.” The present invention allows provides for the accommodation of implementations that have always-on counting, which may be faster in total execution time than first checking if counting is on and then incrementing.

1. A method of counting the printing of graphics in a POS system including a printer having access to memory, said method comprising the steps of:
(a) receiving input data to said printer;
(b) determining whether said input data includes a counting command;
(c) executing said counting command if included in said data;
(d) determining whether said data includes a graphic;
(e) verifying whether said graphic is to be counted; and
(f) incrementing the value of a counter in a counting table programmed in said memory.

2. The method of claim 1, further comprising the step of saving the value of said counter to non-volatile memory after a predetermined number of counts.

3. The method of claim 1, further comprising the step of saving the value of said counter to non-volatile memory after a predetermined time interval.

4. The method of claim 1 further comprising the steps of:
(h) determining whether said counter in said counting table has reached a maximum value;
(i) saving said maximum value in said non-volatile memory; and
(j) resetting said counting table.

5. The method of claim 1, wherein the step of verifying whether said graphic is to be counted comprises the steps of:
(i) determining the ID of said graphic to be counted; and
(ii) matching the ID of said graphic to be counted against an index of graphics to be counted previously stored in said memory.

6. The method of claim 1, wherein said counting command comprises resetting the value of said counter.

7. The method of claim 1, wherein said counting command comprises returning the value of said counter.

8. The method of claim 2, wherein said counting command comprises setting the predetermined number of counts.

9. The method of claim 1, further comprising the step of setting a predetermined time interval.

10. The method of claim 1, wherein said graphic is a logo.

11. The method of claim 1, wherein said graphic is a surround graphic.

12. The method of claim 5, wherein said index comprises graphic IDs.

13. The method of claim 5, wherein said index comprises logo CRCs.

14. A method of counting the printing of graphics in a POS system including a printer having access to memory, said method comprising the steps of:
(a) receiving input data to said printer;
(d) determining whether one or more graphics having predetermined IDs are to be printed;
(e) printing said graphics;
(f) retrieving said IDs from a look-up table including a count value for each said ID;
(g) incrementing said count value for each said graphic printed.

15. The method of claim 14, further comprising the steps of:
(h) determining whether said count value has reached a maximum value; and
(i) recording said count value in non-volatile memory if said maximum has been reached.

16. The method of claim 15, further comprising the step of resetting said count value.

17. The method of claim 14, further comprising the step of returning said count value if said input data contains a command to reset said count value.

18. The method of claim 14, further comprising the step of resetting said count value if said input data contains a command to reset said count value.

19. The method of claim 14, further comprising the step of storing said count value in non-volatile memory if said input data contains a command to store said count value.

20. The method of claim 19, further comprising the step of resetting said count value.

21. The method of claim 20, further comprising the step of retrieving a CRC for said graphic if said input data contains a command to verify said graphic stored at said ID.

22. The method of claim 14, further comprising the step of setting a predetermined time interval.

24. The method of claim 14, further comprising the steps of:
(h) determining whether a predetermined time interval has been reached; and
(i) recording said count value in non-volatile memory if said predetermined time interval has been reached.
